(19) United States
(12) Patent Application Publication
(10) Pub. No.: US 2008/0226335 A1
(43) Pub. Date: Sep. 18, 2008

(54) Image transfer device and method for cleaning a part thereof

(75) Inventors: Lambertus M.L. Van Sas, Helmond (NL); Franciscus M.J. Linssen, Riel (NL); Robbie M.L. Sanders, Swalmen (NL); Bastiaan Appelhof, Helmond (NL)

Correspondence Address: BIRCH STEWART KOLASCH & BIRCH, PO BOX 747, FALLS CHURCH, VA, 22040-0747, US

(73) Assignee: OCÉ-TECHNOLOGIES B.V., Venlo (NL)

(21) Appl. No.: 11/892,253

(22) Filed: Aug. 21, 2007

Related U.S. Application Data
(63) Continuation-in-part of application No. 11/214,769, filed on Aug. 31, 2005, now Pat. No. 7,269,375.

(30) Foreign Application Priority Data
Sep. 1, 2004 (EP) 04077445.7

(51) Int. Cl. G03G 15/16

(52) U.S. Cl. 399/101

(57) ABSTRACT

An image transfer device for a sheet-fed image reproduction system is disclosed in which an improved removal of contaminants from the surface of an image transfer member is possible by using a tacky surface cleaning member contacting the image transfer member surface. The tacky surface of the cleaning member is rejuvenated substantially without affecting the productivity of the image reproduction system by applying predetermined patterns of cleaning substance on the image transfer member surface in the non-image areas, being the part of the inter-image areas coinciding with the inter-sheet areas. Also disclosed is a method for cleaning the image transfer member surface of such image transfer device.

This application is a Continuation-in-Part of co-pending application Ser. No. 11/214,769, filed on Aug. 31, 2005, the entire contents of which are hereby incorporated by reference and for which priority is claimed under 35 U.S.C. § 120.

### FIELD OF THE INVENTION

The present invention is directed to an Image transfer device for transferring images of a marking substance, including ink and toner, from an image transfer member to a recording medium. Furthermore, the present invention is related to a method of removing debris from the surface of the image transfer member of such an image transfer device.

### BACKGROUND OF THE INVENTION

Image reproduction systems, such as printers and copiers, often include an image transfer device having an image transfer member, usually in the form of a belt or a drum, for receiving on its surface a marking substance, such as toner or ink, in image form and for subsequently transferring these images of marking substance In a transfer zone to a recording medium, such as paper. In an operative state, the image transfer member is urged against a counter member in the transfer zone while the recording medium passes therebetween. The transfer may take place by means of pressure, or heat, or heat and pressure each of them optionally being assisted by electrostatic forces and/or vibrational forces. Particularly in case the marking substance is a toner, the marking substance must be fixed onto the receiving material in order to render the images permanent. By applying an appropriate amount of pressure and heat in the transfer zone, transfer and fixing take place simultaneously. Otherwise a subsequent fixing step must be executed. For example, this may be done by feeding the recording medium, onto which the unfixed marking substance is already deposited, through a fixing zone where an increased temperature and pressure serve to fix the image permanently to the recording medium.

In such image transfer devices, contaminants, e.g., in the form of residual marking substance material and/or debris originating from the recording medium and/or other impurities may build up on the surface of the image transfer member. For instance, when the recording medium is paper or a like fibrous material, debris in the form of dust and fibers may build up on the image transfer member surface in the region of the transfer zone. If these contaminants remain on the image transfer member surface, the efficiency of the image transfer and the quality of the fixing, where applicable, may be affected. Hence, it is desirable to clean the surface of the image transfer member.

It is known to provide an endless cleaning member having a tacky substance on its surface and being positioned downstream of the transfer zone for removing contaminants from the image transfer member surface when being engaged in contact therewith. It is also known that over time, the tackiness of the cleaning member is reduced and hence the surface layer of the cleaning member needs to be rejuvenated. As disclosed in U.S. Pat. No. 4,705,388 (Huntjens et al./Océ-Nederland BV) or EP 0994861 (Douvdevani et al./Indigo N. V.), this may, for Instance, be done by periodically developing a non-image pattern of a tacky substance, in casu toner, on an image transfer member to rejuvenate the surface layer of the cleaning member. In such a rejuvenation state, the image transfer member with the non-image toner pattern thereon passes the transfer zone while no recording medium is supplied and without urging the counter member against the image transfer member. The non-image toner pattern on the image transfer member is guided further towards the contact zone between the image transfer member and the cleaning member, i.e. the cleaning zone. When the image transfer member with the non-image toner pattern passes the cleaning zone, the non-image toner pattern is transferred to the cleaning member surface thereby rejuvenating it. The periodic rejuvenation of the tacky surface layer as described is found to lead to inconsistent cleaning characteristics caused by the reduction of the surface tackiness when proceeding in the operative state towards the next rejuvenation period. From this perspective, it seems beneficial to implement a high rejuvenation periodicity. However, contrary to the operative state, in the rejuvenation stage no prints or copies are generated and thus a high rejuvenation period is detrimental for the productivity of the image reproduction device. These conflicting requirements demand for a new approach for rejuvenating the tacky surface of the cleaning member.

### SUMMARY OF THE INVENTION

Thus it is an object of the present invention to provide a device and method in which an improved removal of contaminants from the surface of an image transfer member is possible.

It is still a further object of the present invention to rejuvenate the tacky surface of the cleaning member substantially without affecting the productivity of the image reproduction system.

It is still a further object of the present invention to rejuvenate the tacky surface of the cleaning member by providing refreshment material and simultaneously removing any excess and/or contaminated tacky surface material therefrom.

To meet these objects according to a first aspect of the invention, there is provided an image transfer device for transferring images of a marking substance to sheets of a recording medium, the device including:

an endless image transfer member for receiving consecutive images of a marking substance on its surface, the image transfer member being urged, in an operative state of the transfer device, into contact with a counter member to form a transfer zone therebetween for transferring the respective consecutive images to respective sheets of a recording medium fed consecutively through the transfer zone; and

an endless cleaning member having, in an operative state of the transfer device, a surface in contact with the surface of the image transfer member in a cleaning zone downstream of the transfer zone, the surface of the cleaning member carrying a layer of tacky substance wherein

a controllable applicator unit is utilized for providing, in an operative state of the image transfer device, predetermined patterns of a cleaning substance to the surface of the image transfer member in at least some of the non-image areas, the predetermined patterns of cleaning substance provided on the image transfer member being substantially completely transferred to the surface of the cleaning member in the cleaning zone. The present invention is particularly relevant to printers and copiers where, to enable printing on a wide variety of recording media, at least one image transfer device is provided to transfer an image of marking substance from an image forming device to the recording medium. The feature that non-image patterns of cleaning substance are formed in the non-image areas, i.e., the areas between consecutive images coinciding with the areas between consecutive sheets is advantageous as it allows the rejuvenation of the cleaning member surface, quasi continuously. Furthermore, as this takes place in the operative state, i.e., while sheets of recording medium are fed through the transfer zone and hence prints or copies of images are generated, this rejuvenation process does not negatively affect the productivity of the printer or copier.

More specifically, the image transfer device of the present invention includes an endless image transfer member provided for receiving consecutive images of a marking substance on its surface, the image transfer member being urged. In an operative state of the transfer device, into moving contact with a counter member to form a transfer zone therebetween for transferring the respective consecutive images to respective sheets of a recording medium fed consecutively through the transfer zone; a first endless cleaning member having, in an operative state of the image transfer device, a surface in moving contact with the surface of the image transfer member in a first cleaning zone downstream of the transfer zone, the surface of the first cleaning member carrying a layer of tacky substance; a second endless cleaning member having, in an operative state of the image transfer device, a surface in moving contact with the surface of the counter member in a second cleaning zone downstream of the transfer zone, the surface of the second cleaning member carrying a layer of tacky substance; and a controllable applicator unit for providing, in an operative state of the image transfer device, predetermined patterns of a cleaning substance to the surface of the image transfer member in at least some non-image areas, the non-image areas being the areas between consecutive images coinciding with the areas between consecutive sheets, the predetermined patterns of cleaning substance transferred onto the counter member being substantially completely transferred to the surface of the second cleaning member in the second cleaning zone, and the predetermined patterns of cleaning substance remaining on the image transfer member downstream of the transfer zone being substantially completely transferred to the surface of the first cleaning member in the first cleaning zone.

The cleaning member and the counter member may be selectively movable into and out of contact with the image transfer member surface and may be independently driven. Alternately, these items can be driven by the movement of the Image transfer member.

The image transfer member may be in the form of a drum or a belt and may be heated.

In case the image transfer member is a belt a first and second backing roller may be provided, the first backing roller cooperating with the cleaning member to form the cleaning zone through which the belt passes, the second backing roller contacting the back of the image transfer belt opposite the counter member such that in the transfer zone both the belt and the recording medium pass while pressure is exerted on at least one of the second backing roller and the counter member to define the contact.

The image transfer member typically has an outer layer of a silicone elastomer. The counter member typically has an outer layer of a silicone elastomer, or a PTFE, or a fluororubber. To ensure that substantially all the cleaning substance remains on the image transfer member surface in the transfer zone where both members contact each other, the outer layer of the counter member may be chosen such that it has a lower affinity to the cleaning substance than the outer layer of the image transfer member. When part of the cleaning substance transfers to the counter member surface, a cleaning member with a tacky surface may also be engaged in contact with the counter member. Alternately one can also opt to move the counter member out of contact with the image transfer member in the time interval between two consecutive sheets in order to ensure that the cleaning substance remains on the image transfer member surface in the transfer zone. However, this is less preferred as the disengagement and subsequent engagement of the counter member after each sheet negatively influences reliability and image quality, in particular image registering.

The cleaning member usually is a cleaning roller, although also a cleaning web may be used. The cleaning roller is located downstream of the transfer zone and upstream of any intermediate transfer zone where images of marking substance are transferred to the image transfer member directly from an image forming member or indirectly via one or more further image transfer members. The kind of marking substance and image forming member which is used depends on the imaging technique which is used. Examples of imaging techniques include ink jet, electrography including electrophotograpy, and magnetography. Examples of marking substance include ink, dry particulate toner, and liquid toner. For instance in the case of electrophotography, the marking substance may be a dry particulate toner, while the image forming member is a drum or a belt with a photoconductive outer layer whereon a latent image is formed and subsequently developed with toner.

The tacky surface layer material and the cleaning substance can be formed of polymeric material having good adhesive and adsorptive properties, especially at the operating temperatures of the image transfer member. Preferably, the cleaning substance comprises a polymer having a glass transition temperature below the temperature of the image transfer member at the cleaning zone. Such polymeric material may be toner, as a toner typically comprises a thermoplastic binder consisting of a thermoplastic resin or a mixture of resins including coloring matter, e.g., carbon black or coloring material such as finely dispersed pigments or soluble dyes. The toner used as the cleaning substance may be one of the toners used as the marking substance for rendering the images. Alternately, it is also possible to use toner of a different composition as a cleaning substance, for example containing a lower level of coloring material, or even no coloring material at all.

The applicator unit may be a simple dosing unit, which is able to supply fresh cleaning substance at a controllable rate and dose to predetermined locations of the moving image transfer member and according to a predetermined pattern. An example of such dosing unit is a spray coating unit. Particularly in the case where the cleaning substance is a toner or toner-like material, the controllable applicator unit may be an image forming unit. In the latter case a predetermined pattern of cleaning substance is imaged directly on the image forming member in some or each of the non-image areas. Alternately, a latent image pattern is first formed on the image forming member and subsequently developed thereon. The predetermined pattern of cleaning substance may be transferred in an intermediate transfer zone to the image transfer member directly from an image forming member or indirectly via one or more further intermediate image transfer members. Alternately, the image forming member may constitute the image transfer member. The transferred pattern of cleaning substance present on the image transfer member passes the transfer zone. The remaining part of the pattern of cleaning substance present on the image transfer member downstream of the transfer zone is transferred substantially completely to the cleaning member in the cleaning zone.

In one embodiment of the present invention, the cleaning member is a rotatable cleaning roller having a surface with a plurality of spaced-apart perforations therein for discharging any contaminants and excess cleaning substance assembled on the cleaning roller surface into a cavity in the cleaning roller. For instance, the perforations may be in the form of grooves. An advantage thereof is that the building up on the cleaning member surface of any excess tacky substance possibly mixed with contaminants is prevented. The cleaning roller may be constructed of a metal such as steel or aluminium. The cleaning roller, however, may also be made of other heat-resistant material to the extent comporting with the operating temperature thereof. Such heat-resistant materials may include heat-resistant plastics. Optionally a perforated conformable layer may be provided on the cleaning member core material. In any case, the tacky layer is formed on the cleaning member outer surface. The cleaning member can include a first and second cleaning member, each one of the first and second cleaning member having a surface with a plurality of spaced-apart perforations therein for discharging any contaminants and excess cleaning substance collected on the cleaning roller surface.

In a further embodiment of the present invention, means are provided for synchronizing the position of the perforations in the cleaning member and the predetermined patterns of cleaning substance disposed on the image transfer member to ensure that in the cleaning zone the cleaning substance is only present on the image transfer member surface outside the perforations. The means for synchronizing the position may include a position sensor for determining the axial position of the cleaning member. Advantageously, the perforations in the cleaning member are grooves.

In yet a further embodiment of the present invention, the patterns of cleaning substance on the image transfer member are such that the portions of the image transfer member surface, covered by the patterns of cleaning substance, have an area coverage in the range from 1% to 30%. It is observed that by lowering the area coverage of the exposed portions, the transfer efficiency of cleaning substance to the counter member surface in the transfer zone can be effectively reduced. The means for synchronising the predetermined patterns of cleaning substance with the positions of the perforations of the first and second cleaning rollers includes positions sensors for determining the radial position of the first and second cleaning rollers.

According to a second aspect of the present invention, there is provided a method of removing contaminants from the surface of an endless image transfer member of a transfer device in which, in operation, the endless image transfer member is urged into contact with a counter member to form a transfer zone therebetween through which consecutive sheets of a recording medium are fed. The method includes the steps of contacting the image transfer member surface at a cleaning zone with an endless cleaning member having a tacky surface layer of cleaning substance, thereby transferring contaminants from the image transfer member to the tacky surface; and receiving consecutive images of a marking substance on the image transfer member and transferring the respective consecutive images in the transfer zone to the respective consecutive sheets. According to the present method patterns of a cleaning substance are provided on the image transfer member in at least some non-image areas, between at least some of the consecutive images, the non-image areas being the areas between consecutive images coinciding with the areas between consecutive sheets, the non-image patterns of cleaning substance being substantially completely transferred to the surface of the cleaning member in the cleaning zone.

More specifically, the method of removing contaminants from the surface of an endless image transfer member of an image transfer device, in which, in operation the endless image transfer member is urged into contact with a counter member to form a transfer zone therebetween, through which consecutive sheets of a recording medium are fed, includes the steps of contacting the image transfer member surface in a first cleaning zone with a first endless cleaning member with protrusions having a tacky surface of cleaning substance and perforations, thereby transferring contaminants from the image transfer member to the tacky surface of the first endless cleaning member; contacting the counter member surface in a second cleaning zone with a second endless cleaning member with protrusions having a tacky surface of cleaning substance and perforations, thereby transferring contaminants from the counter member to the tacky surface of the second endless cleaning member; receiving consecutive images of a marking substance on the image transfer member and transferring the respective consecutive images in the transfer zone to the respective consecutive sheets; providing patterns of cleaning substance on the image transfer member in at least some non-image areas, between at least some of the consecutive images, the non-image areas being the areas between consecutive images coinciding with the areas between consecutive sheets, the patterns of cleaning substance transferred onto the counter member being substantially completely transferred to the surface of the second cleaning member in the second cleaning zone, and the patterns of cleaning substance remaining on the image transfer member downstream of the transfer zone being substantially completely transferred to the surface of the first cleaning member in the first cleaning zone.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is a schematic illustration of a printer according to an embodiment of the present invention;

FIG. 2A is a schematic representation of the cleaning member according to an embodiment of the present invention; and

FIG. 2B is a cross-sectional view of the cleaning member.

FIG. 3A is a schematic representation of a second cleaning member according to an embodiment of the present invention.

FIG. 3B is a cross-sectional view of the second cleaning member.

FIG. 4 is a flow diagram showing steps of a method of removing contaminants according to an embodiment of the present invention.

FIG. 5 is a schematic representation of a fully covered bitmap.

FIG. 6A is a schematic representation of an intermediate pattern.

FIG. 6B is a schematic representation of a pattern to be formed on the image transfer member.

FIG. 7A is a schematic representation of another intermediate pattern.

FIG. 7B is a schematic representation of another pattern to be formed on the image transfer member.

### DETAILED DESCRIPTION OF THE INVENTION

In relation to the appended drawings, the present invention is described in detail in the sequel. Several embodiments are disclosed. It is apparent however that a person skilled in the art can imagine several other equivalent embodiments or other ways of executing the present invention.

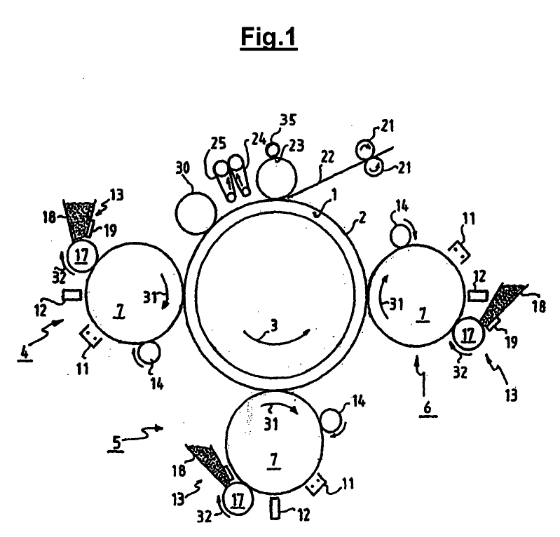

A printing system capable of printing on sheets of a recording medium is depicted in FIG. 1. The printing system includes an image transfer member, which can be moved cyclically. The image transfer member is an endless member, such as e.g., a drum or a belt. In this case the image transfer member is a cylindrical drum 1, which can be moved in the direction of arrow 3. The image transfer member is constructed of a metal sleeve, e.g., aluminium, with an elastomeric covering 2. Optionally, the image transfer member may be provided with an outer layer of silicone rubber, e.g., by means of a coating. One or more process colors are available on the printing system dependent on whether or not it concerns a monochrome or a multi-color printing system. For each process color, an image forming unit or controllable application 4, 5, and 6 is disposed along the path of rotation of the intermediate transfer member. Each of these image forming units comprises a cylindrical image forming member 7 on which a color separation image of the corresponding process is formed. In an operative state, the image forming members are all in pressure contact with the image transfer member, the force with which the image forming members are pressed against the image transfer member being at maximum, 1000 N per linear meter, e.g., 250 N per linear meter. The cylindrical drum can be replaced with a belt and backing roller. Each image forming member is formed of a metal drum with a photo-conductive outer layer thereon, the various image forming devices being positioned along the circumference of the image forming member. These image forming devices comprise a charging device 11, e.g., a corona device, an exposing device 12, e.g., a LED array, for image-wise exposure of the photo-conductive surface to thereby form a latent charge image thereon, a development device 13 for developing the latent image with marking substance, a cleaning device 14 for removing any residual marking substance present on the image forming member after transfer of the developed separation image to the image transfer member. The development device is in this case a magnetic brush development device which includes a magnetic roller 17 containing a rotatable sleeve with a stationary magnetic system therein. The magnetic roller is positioned along the circumference of the image forming member with its surface at short distance from the image forming member surface without contacting it. A reservoir 18 with electrically conductive magnetically attractable dry particulate toner is positioned near the surface of each of the magnetic rollers 17. Each reservoir contains toner in one of the process colors. A stripper 19 is provided at each reservoir to ensure that an even layer of particulate toner is applied to the sleeve of the magnetic roller.

Also, disposed along the path of rotation of the image transfer member 1 is a rotatable counter roller 23 which is selectively movable towards and away from the image transfer member surface with controlled pressure. Means (not shown) are provided to drive this counter member. When pressing the counter member against the image transfer member surface a transfer zone is defined through which, in operation, sheets of recording medium are passed using feed means and sheet discharging means. This feed means consists of co-operating conveyor rollers 21 and a guide plate 22. The sheet discharging means includes co-operating conveyor belts 24, 25.

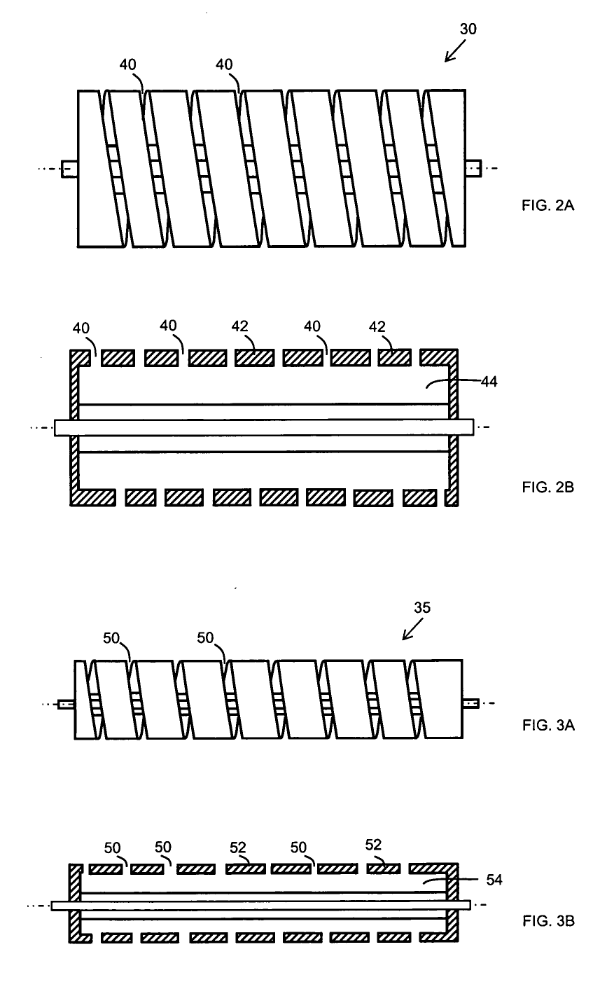

Further disposed along the path of rotation of the image transfer member 1 downstream of the transfer zone is a rotatable cleaning roller having a tacky surface. The cleaning roller 30, as shown in FIGS. 2A and 2B, may be driven by drive means (not shown) and is selectively movable into and out-of an operative position where the cleaning member surface is in contact with the image transfer member surface. A helical perforation 40 is formed in the cleaning roller surface and extends to a cavity 44 within the roller for discharging any contaminants and/or excess cleaning substance assembled on the roller surface thereof. This helical perforation 40 defines, in the axial, direction an alternating pattern of grooves and non-perforated areas, referred to as dams 42. Although these parameters are not that critical, the width and pitch of the perforation is of importance as they determine the ratio between the cleaning area and the non-cleaning area of the roller. As cleaning is only performed in the dam area and not in the grooves, proper consideration should be given when determining these parameters. A large cleaning area is desirable but account should be taken of the fact that the contaminants and/or excess cleaning substance assembled on the cleaning roller surface dams must be able to reach the grooves. Hence, for instance the viscosity of the cleaning substance should be involved in this consideration. A position sensor (not shown) is provided to detect the axial position and optionally also the radial position of the cleaning roller as well as control means (also not shown) for controlling the position of the cleaning roller responsive to the detected position.

The tackiness of the surface layer of the cleaning roller may be improved and the viscosity of the layer may be adjusted by heating the surface layer upstream of the cleaning zone. To enable this, a heating device may be provided for heating the cleaning substance on the cleaning roller surface to render the surface tacky prior to its contact with the transfer member surface. The heating device may be in the form of a lamp located in the inner core of the roller. Alternatively, especially when the cleaning roller has a conformable surface, external heating is preferred, for example by use of an external radiant heat source. Ideally, means are provided for controlling the heating of the toner particles, for example by the use of a heat sensor to sense the temperature of the cleaning member surface, this sensor being coupled to a control device for the heating device. Heating the toner particles on the cleaning roller surface has several benefits. The heating device can be energized selectively to control the temperature and tackiness of the cleaning roller surface. This is especially beneficial at start up where, in the absence of such a heating device, it would take a significant amount of time (and possibly wastage of receiving material) before the temperature equilibrium would be reached.

In operation, in order to reproduce an image a sequence of printing signals is generated. Responsive to this sequence of printing signals the printing system sequentially forms the respective separation images of marking substance of the corresponding process color on the respective image forming members 7. In the respective pressure contact zones, the respective separation images are sequentially transferred in register to the image transfer member to thereby form a registered multi-color image thereon. The marking substance is toner, in dry particulate form. The registered multi-color toner image on the image transfer member is heated by means known per se so that the toner softens and is rendered tacky. The printing system is such that the respective separation images of marking particles are formed complementary. This means that marking particles of a process color are accumulated on the free surface of the image-carrying member and substantially not on colored marking particles already accumulated on the image-carrying member. Substantially not means that any superimposed marking particles of different process colors may not lead to visual deficiencies, i.e. visual with the naked human eye, in the finally printed image.

The printing system subsequently transfers the registered multi-color toner image to a sheet of a recording medium which is controllably fed at the appropriate time by the conveyor rollers 21 through the transfer zone defined by establishing pressure contact between the rotating image transfer member and the rotating counter member. The sheet carrying the printed image is subsequently discharged by the co-operating conveyor belts 24 and 25. The image transfer member is further advanced towards the cleaning zone where any contaminants present on its surface may be removed by transferring them to the tacky surface of the rotating cleaning roller 30. The cleaning roller 30 can be provided with a position sensor 36 to monitor the axial position of the cleaning roller. When printing consecutive images, e.g., a document of several pages and/or plural copies of a single image or document, the printing job is defined such that the consecutive images are printed each on separate sheets fed consecutively through the transfer zone. Hence, for consecutive images both an inter-image area, being the area between consecutive images carried on the image transfer member, can be defined as well as an inter-sheet area, being the distance between the associated consecutive sheets. The part of the inter-image area coinciding with the inter-sheet area is referred to as the non-image area. According to the present invention, a predetermined pattern of cleaning substance is formed in the non-image area. This may be done by imaging a predetermined pattern on the image forming member of one of the available process colors and subsequently developing it thereon with the corresponding toner. The toner, preferably black toner when available, used to form this predetermined pattern constitutes the cleaning substance. The image forming unit and the formation process of the predetermined pattern is controlled such that the transfer of the cleaning substance pattern to the image transfer member in the pressure contact zone is effected in the non-image area. When the cleaning substance pattern in the non-image area reaches the transfer zone in the interval between two consecutive sheets, it can not be transferred to a sheet but instead will remain on the surface of the image transfer member or will be (partially) transferred to the counter member surface 23. When the image transfer member is moved further to the cleaning zone the cleaning substance pattern or at least the residual part thereof will be transferred to the dams of the tacky cleaning roller surface 30 thereby rejuvenating the tacky surface layer. To ensure that substantially all cleaning substance is removed from the image transfer member surface in the cleaning zone a pattern is selected which can be synchronised with the cleaning member using the cleaning roller position detection and controlling means such that the cleaning substance is only present in the cleaning zone in the area coinciding with the dams of the cleaning roller. For example, when the pitch of the helical perforation is 3.5 mm and the groove width (dimension in axial direction) is 0.8 mm, typically a pattern is chosen having a dam width of about 1.1 mm which is well within the dam width of the cleaning roller. The dams of the pattern constitute the portions of the image transfer member surface in the non-image area covered with cleaning substance, while the dam width of the pattern is the width of the covered portions in the non-image area.

As previously stated, when a cleaning substance pattern in a non-image area reaches the transfer zone in the interval between two consecutive sheets, it will remain on the surface of the image transfer member or will be (partially) transferred to the counter member surface 23. To avoid that the cleaning substance transferred to the counter member contaminates the back of subsequent sheets and transferred back to the image transfer members surface, a tacky surface cleaning roller 35 may also be provided to clean the counter member surface. Instead of providing the additional cleaning roller or in combination with the additional cleaning roller, one can also opt to take appropriate measures to severely reduce or even nullify the transfer rate of cleaning substance to the counter member surface. One or these measures could be the use of a counter member surface layer having a lower affinity to cleaning substance compared to the image transfer member surface layer. Examples of such counter member surface layers are polyorganosiloxane layers, in particular the ones disclosed in EP0349072 (Schoustra et al., Océ Technologies B. V.). Instead of or in addition to this measure, on could also opt to lower the area coverage of the portions of the image transfer member surface in the non-image area covered by the patterns of cleaning substance, as it has been observed that this is beneficial to reduce the transfer rate of cleaning substance to the counter member surface. For instance the area coverage may be chosen typically in the range of from 1% to 30%, or from 1% to 10%, or from 1% to 5%.

In another embodiment of the image transfer device, the cleaning roller 30 carrying on its surface a layer of tacky substance is provided to clean the surface 2 of the image transfer member 1. The cleaning roller 30 is arranged for cleaning the surface of the image transfer member 1 in a first cleaning zone downstream of the transfer zone.

Moreover, a second cleaning roller 35 having a tacky surface is provided to clean the surface of the counter member 23. The cleaning roller 35 is useful, because when a cleaning substance pattern in a non-image area reaches the transfer zone in the interval between two consecutive sheets, the cleaning substance pattern is partially transferred on the surface of the counter member 23. The cleaning roller 35 having a tacky surface avoids that the cleaning substance which has been transferred onto the counter member 23 contaminates the back of subsequent sheets and the image transfer member. The second cleaning member 35 has, in an operative state of the image transfer device, a surface in moving contact with the surface of the counter member 23 in a second cleaning zone downstream of the transfer zone, taken along the outer circumference of the counter member 23.

The second cleaning roller 35 may be driven by drive means (not shown) and is arranged such that the cleaning member surface is in contact with the counter member 23. Details of the second cleaning roller 35 are shown in FIGS. 3A and 3B. The second cleaning roller 35 may be identical to the first cleaning roller 30. However, alternately, it may have different dimensions and carry a pattern of perforation which is different from the first cleaning roller 35. In the example detailed hereinafter, it is assumed that the circumference of the second cleaning roller 35 is one third of the circumference of the first cleaning roller 30.

A helical perforation 50 is formed in the surface of the cleaning roller 35 and extends to a cavity 54 within the roller 35 for discharging any contaminants and/or excess cleaning substance assembled on the roller surface. The helical perforation 50 defines, in the axial direction, an alternating pattern of grooves and non-perforated areas, referred to as dams 52. Cleaning is performed in the dam areas and not in the grooves. As for the first cleaning roller 30, proper consideration should be given when determining the width and the pitch of the grooves. A position sensor (not shown) is provided to detect the radial position of the cleaning roller 35.

According to the present invention, a predetermined pattern of cleaning substance is formed in the non-image area. This may be done by imaging a predetermined pattern on the surface of the image forming member 1. The toner, preferably black toner when available, used to form the predetermined pattern constitutes the cleaning substance. The image forming unit (4, 5, and/or 6) for forming the predetermined pattern of the cleaning substance and the formation process of said predetermined pattern is controlled such that the transfer of the cleaning substance pattern to the image transfer member 1 in the pressure contact zone is effected in the non-image area.

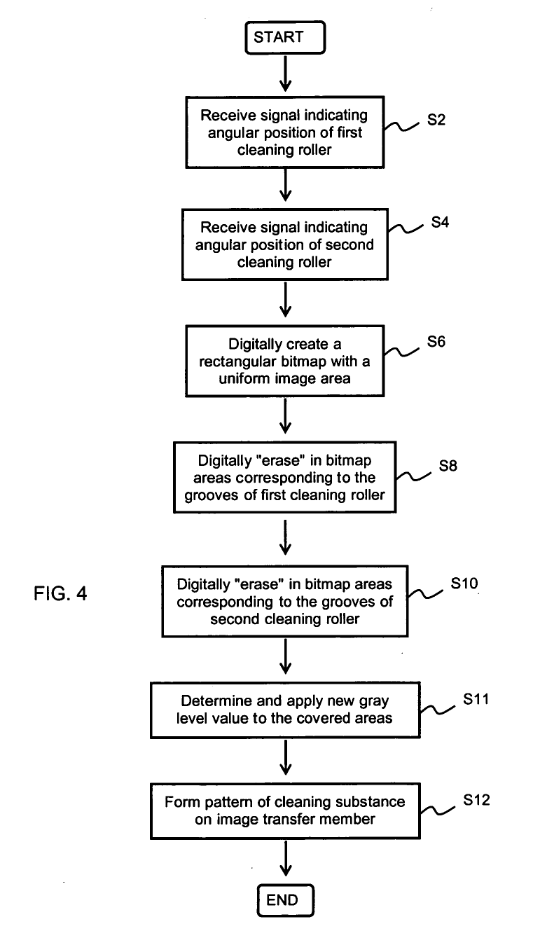

A method comprising steps shown in FIG. 4 is now described to control the pattern of cleaning substance to be formed in the non-image area.

In step S2, the controller receives a signal from the position sensor which is provided to detect the radial position of the cleaning roller 30. In step S4, the controller receives a signal from the position sensor which is provided to detect the radial position of the cleaning roller 35. Based on the received information regarding the radial position of the cleaning rollers, steps are executed by a processor of the controller to determine the pattern that is to be formed in the non-image area on the image forming member.

The processor of the controller then carries out the steps S6, S8 and S10 to determine the pattern, based on the knowledge of the angular position of each one of the cleaning rollers, and on other process parameters such as lengths of the image forming member, speed of advance of said image forming member, physical dimensions of each one of the cleaning rollers and their rotational speed.

The processor, in step S6 digitally creates an initial bitmap, for example the rectangle 56 represented in FIG. 5. It has preferably a uniform coverage degree (easily translated into a gray level value), which may be changed in step S11. If this bitmap was transmitted to the controller for image formation purposes, a rectangle uniformly covered by the cleaning substance (preferably black toner) would be formed by an imaging forming unit (4, 5, and/or 6) on the image forming member. However, this digitally created rectangle is modified to create the pattern.

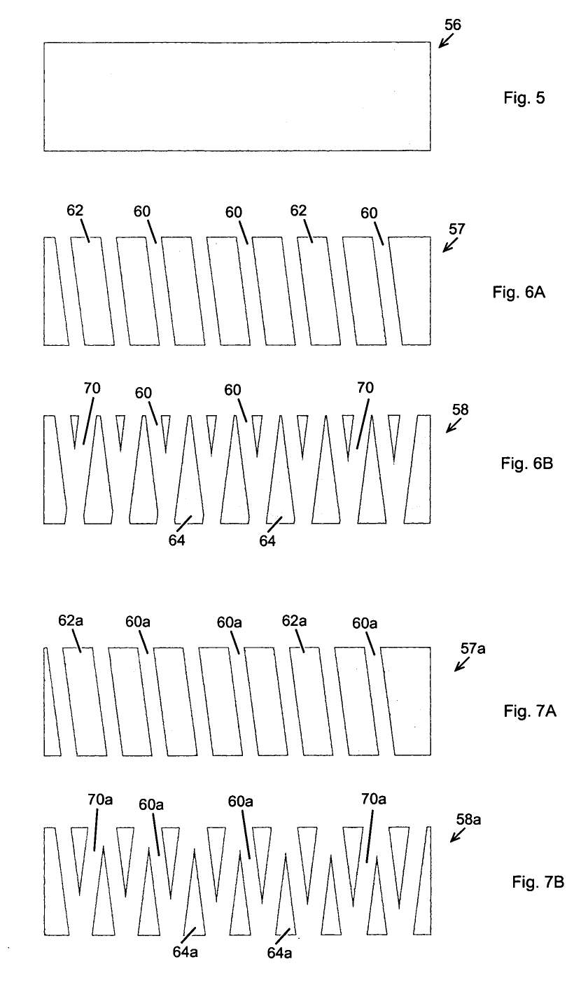

In step S8, the processor executes the step of digitally erasing from the initial bitmap 56 areas corresponding to the grooves of the cleaning roller 30. As is shown in FIG. 6A, a bitmap having a pattern 57 is obtained wherein the digitally erased areas 60 correspond to the grooves 40 of the cleaning roller 30. The stripes 62 are non-erased areas, corresponding to the dams 42 of the cleaning roller 30. The exact position of the areas 60 and 62 depends, among others, on the angular position of the cleaning roller 30. The pattern 57 is so calculated that when the pattern of cleaning substance would reach the cleaning zone between the roller 30 and the surface 2 of the image transfer member 1, the stripes 62 would be removed by the dams 42 of the cleaning roller 30. For example, when the pitch of the helical perforation in the cleaning roller 30 is 3.5 mm and the width of the grooves 40 is 0.8 mm (the width of the dams is then 2.7 mm), the width of the stripes 62 in the pattern 57 may be 1.1 mm which is well the width of the dams 42 of the cleaning roller 30. If the pattern 57 of cleaning substance was formed on the image transfer member surface 2 in the non-image area, the stripes 62 in the pattern 57 would constitute the portions on the surface 2 covered with cleaning substance which correspond to the locations of the dams 42 of the cleaning roller 30 in the first cleaning zone. However, if this pattern 57 was formed by an image forming unit (4, 5, or 6) on the surface 2 of the image transfer member, a part of the pattern 57 of cleaning substance would be transferred onto the counter member 23. This situation should preferably be avoided because it would cause contamination by the cleaning substance of the back of subsequent sheets Then, the cleaning substance would be transferred back to the surface of the image transfer member. To solve this problem, step S10 is executed.

In step S10, the processor executes the step of digitally erasing from the bitmap 57 areas corresponding to the grooves of the cleaning roller 35. As is shown in FIG. 6B, a bitmap having a pattern 58 is now obtained wherein the digitally erased areas 70 correspond to the grooves 50 of the cleaning roller 35. The stripes 64 are non-erased areas, corresponding to the dams 42 of the cleaning roller 30 and to the dams of the cleaning roller 35. The exact position of the areas 70 and 64 depends, among others, on the angular position of the cleaning roller 35. The pattern 58 is so calculated that, when the pattern 58 of cleaning substance which has been transferred onto the counter member 23 reaches the second cleaning zone between the roller 35 and the counter member 23, the toner particles having been transferred onto the counter member 23 and occupying on the areas 64 are fully removed from the counter member 23 by the dams 52 of the cleaning roller 35. When the pattern 58 of cleaning substance which remains on the surface 2 of the image transfer member after having passed the transfer zone reaches the first cleaning zone between the surface 2 of the image transfer member 1 and the cleaning roller 30, the toner particles remaining on the surface 2 of the image transfer member 1 are fully removed from said surface 2 by the dams 42 of the cleaning roller 30.

A mathematical way to described the pattern 58 shown in FIG. 6B uses the mathematical OR function. The erased areas 60 and 70 in the pattern 58 are areas corresponding to the grooves 40 of the cleaning roller 300R to the grooves 50 of the cleaning roller 35. This ensures that the pattern 58 of the cleaning substance, having a first part transferred onto the counter member 23 and a second part remaining on the image transfer member's surface, is fully removed form the surface of the counter member 23 (first part) and from the surface 2 of the image transfer member 1 (second part).

In the case that two cleaning rollers are provided in the image transfer device, the pattern 58 shown in FIG. 6B thus becomes the predetermined pattern of the cleaning substance. In the case that more cleaning members are provided, the steps of digitally erasing areas in the bitmap are repeated.

In step S11, a signal is received from the controller that is indicative of the amount of toner used in the previous printing cycles. Depending on the toner consumption and on the pattern 58 obtained in step S10, a new uniform coverage degree (easily translated into a gray level value) to be applied to the covered areas in the pattern 58 may be determined. Then, it is applied to the covered areas in the bitmap corresponding to the pattern 58. Depending also on the number of printing cycles between the moments at which toner is dosed for refreshing the cleaning rollers, preferred coverage degrees are in the range 6-18% or 3-9%.

In step S12, the controller controls the image forming unit (4, 5, or 6) selected for forming the predetermined pattern of cleaning substance such that the pattern of cleaning substance 58 is formed on the surface 2 of the image transfer member.

Depending on the angular position of the cleaning rollers 30 and 35, the pattern of cleaning substance to be formed in non-image areas will be different. In FIG. 7A, an intermediate pattern 57a is shown. The areas 60a correspond to digitally erased areas, corresponding to the grooves 40 of the cleaning roller 30. The areas 62a are digitally non-erased areas, corresponding to the dams 42 of the cleaning roller 30. In FIG. 7B, a pattern 58a to be printed in non-image areas is represented. Since the relative angular position of the cleaning rollers 30 and 35 differs from the situation represented before, the pattern 58a differs from the pattern 58. The erased areas 60a and 70a in pattern the 58a are areas corresponding to the grooves 40 of the cleaning roller 300R to the grooves 50 of the cleaning roller 35. This ensures that the pattern 58a of the cleaning substance is fully removed form the surface of the counter member 23 and from the surface 2 of the image transfer member 1. The digitally erased stripes 60a and 70a correspond, respectively, at least to the positions of the grooves 40 and 50 of the cleaning rollers 30 and 35.

In the embodiment discussed above, an image transfer device having two cleaning rollers have been described. In particular, a method is provided for determining the pattern of cleaning substance to be formed in non-image areas. It is understood that the method described by the mathematical “OR” function can be applied when an image transfer device has even more cleaning members. The pattern is created such that the digitally removed areas correspond at least to the grooves of all cleaning members.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image transfer device for transferring images of a marking substance to sheets of a recording medium which comprises:
an endless image transfer member provided for receiving consecutive images of a marking substance on its surface, the image transfer member being urged, in an operative state of the transfer device, into moving contact with a counter member to form a transfer zone therebetween for transferring the respective consecutive images to respective sheets of a recording medium fed consecutively through the transfer zone;
a first endless cleaning member having, in an operative state of the image transfer device, a surface in moving contact with the surface of the image transfer member in a first cleaning zone downstream of the transfer zone, the surface of the first cleaning member carrying a layer of tacky substance;
a second endless cleaning member having, in an operative state of the image transfer device, a surface in moving contact with the surface of the counter member in a second cleaning zone downstream of the transfer zone, the surface of the second cleaning member carrying a layer of tacky substance; and
a controllable applicator unit for providing, in an operative state of the image transfer device, predetermined patterns of a cleaning substance to the surface of the image transfer member in at least some non-image areas, the non-image areas being the areas between consecutive images coinciding with the areas between consecutive sheets,
the predetermined patterns of cleaning substance transferred onto the counter member being substantially completely transferred to the surface of the second cleaning member in the second cleaning zone, and
the predetermined patterns of cleaning substance remaining on the image transfer member downstream of the transfer zone being substantially completely transferred to the surface of the first cleaning member in the first cleaning zone.

2. The image transfer device according to claim 1, wherein each one of the first and second cleaning member is a cleaning roller having a surface with a plurality of spaced-apart perforations therein for discharging any contaminants and excess cleaning substance collected on the cleaning roller surface.

3. The image transfer device according to claim 2, wherein the perforations are grooves.

4. The Image transfer device according to claim 2, further including means for synchronising the predetermined patterns of cleaning substance with the positions of the perforations of the first and second cleaning rollers to ensure that in the first and second cleaning zones, cleaning substance is only present on the image on the image transfer member surface outside the perforations.

5. The image transfer device according to claim 4, wherein said means for synchronising the predetermined patterns of cleaning substance with the positions of the perforations of the first and second cleaning rollers includes positions sensors for determining the radial position of the first and second cleaning rollers.

6. An image transfer device for transferring images of a marking substance to sheets of a recording medium which comprises:
an endless image transfer member provided for receiving consecutive images of a marking substance on its surface, the image transfer member being urged, in an operative state of the transfer device, into moving contact with a counter member to form a transfer zone therebetween for transferring the respective consecutive images to respective sheets of a recording medium fed consecutively through the transfer zone;
a plurality of endless cleaning members whereby each endless cleaning member has, in an operative state of the image transfer device, a surface in moving contact with a surface of the image transfer device in a cleaning zone downstream of the transfer zone, the surface of each cleaning member carrying a layer of tacky substance; and
a controllable applicator unit for providing, in an operative state of the image transfer device, predetermined patterns of a cleaning substance to the surface of the image transfer member in at least some non-image areas, the non-image areas being the areas between consecutive images coinciding with the areas between consecutive sheets,
the predetermined patterns of cleaning substance transferred onto the surfaces of the image transfer device being substantially completely transferred to the surfaces of the plurality of cleaning members in the cleaning zones.

7. A method of removing contaminants from the surface of an endless image transfer member of an image transfer device, in which, in operation the endless image transfer member is urged into contact with a counter member to form a transfer zone therebetween, through which consecutive sheets of a recording medium are fed, which comprises:
contacting the image transfer member surface in a first cleaning zone with a first endless cleaning member with protrusions having a tacky surface of cleaning substance and perforations, thereby transferring contaminants from the image transfer member to the tacky surface of the first endless cleaning member;
contacting the counter member surface in a second cleaning zone with a second endless cleaning member with protrusions having a tacky surface of cleaning substance and perforations, thereby transferring contaminants from the counter member to the tacky surface of the second endless cleaning member;
receiving consecutive images of a marking substance on the image transfer member and transferring the respective consecutive images in the transfer zone to the respective consecutive sheets;
providing patterns of cleaning substance on the image transfer member in at least some non-image areas, between at least some of the consecutive images, the non-image areas being the areas between consecutive images coinciding with the areas between consecutive sheets, the patterns of cleaning substance transferred onto the counter member being substantially completely transferred to the surface of the second cleaning member in the second cleaning zone, and
the patterns of cleaning substance remaining on the image transfer member downstream of the transfer zone being substantially completely transferred to the surface of the first cleaning member in the first cleaning zone.

8. The method of removing contaminants according to claim 7, comprising the steps of determining the pattern by creating a digital image comprising empty areas and covered areas, wherein the covered areas correspond to areas in the pattern where cleaning substance is formed and the empty areas correspond to areas in the pattern where cleaning substance is absent,
wherein an OR-function is applied to the positions of the perforations of the first and second cleaning members in the first and second cleaning zones when the pattern reaches the first and second cleaning zones, the result of the OR-function substantially corresponding to the locations of the empty areas in the digital image.

9. The method of removing contaminants according to claim 8, comprising receiving a first signal indicative of the angular position of the first cleaning member and receiving a second signal indicative of the angular position of the second cleaning member.

10. A method of removing contaminants from the surface of an endless image transfer member of an image transfer device, in which, in operation the endless image transfer member is urged into contact with a counter member to form a transfer zone therebetween, through which consecutive sheets of a recording medium are fed, which comprises:
contacting surfaces of the image transfer device in a plurality of cleaning zones with a plurality of endless cleaning members having protrusions with a tacky surface of cleaning substance and perforations, thereby transferring contaminants from the image transfer device surfaces to the tacky surfaces of the plurality of endless cleaning members;
receiving consecutive images of a marking substance on the image transfer member and transferring the respective consecutive images in the transfer zone to the respective consecutive sheets;
providing patterns of cleaning substance on the image transfer member in at least some non-image areas, between at least some of the consecutive images, the non-image areas being the areas between consecutive images coinciding with the areas between consecutive sheets, the patterns of cleaning substance transferred onto the image transfer device surfaces being substantially completely transferred to the surfaces of the plurality of endless cleaning members in plurality of cleaning zones.
